(19) United States
(12) Patent Application Publication
(10) Pub. No.: US 2026/0367782 A1
(43) Pub. Date: Nov. 19, 2026

(54) SYSTEMS AND METHODS FOR ADAPTING DISPLAY FOR SHORTCUTS ON KEYBOARDS

(71) Applicant: Huawei Technologies Co., Ltd., Shenzhen (CN)

(72) Inventors: Chenyang Zhang, Markham (CA); Yuan Deng, Markham (CA); Wei Li, Toronto (CA); Baijian Chen, Unionville (CA); Che Yan, Toronto (CA)

(21) Appl. No.: 19/264,538

(22) Filed: Jul. 9, 2025

Related U.S. Application Data
(60) Provisional application No. 63/807,297, filed on May 16, 2025.

(51) Int. Cl. G06F 3/04886; G06F 9/54; G06F 3/044

(52) U.S. Cl. CPC G06F 3/04886; G06F 9/543; G06F 3/044; G06F 2203/04803; G06F 2203/04808

(57) ABSTRACT

Methods and devices for altering display of a virtual keyboard to show shortcut hints based on current context. Shortcut key mappings indicate shortcut user interface configuration associated with particular shortcuts. On detection of a shortcut activation key, a computing device modifies the display of a virtual keyboard based on the shortcut key mappings to show shortcut hints on the associated keycaps. Current context may include active operating system, active application, or current task or state within an active application. Shortcut hint display may be based on priority or ranking of shortcuts, which may be determined based on user configuration or based on tracking usage over time.

### CROSS-REFERENCE TO RELATED APPLICATION

The present application claims priority to US Provisional Patent Application no. 63,807,297, filed May 16, 2025, the contents of which are hereby incorporated by reference.

### FIELD OF THE DISCLOSURE

The present disclosure relates generally to keyboard displays, and in particular to systems and methods for adapting display for shortcuts on keyboards.

### BACKGROUND

Keyboard shortcuts are used widely in every OS and major applications. However, it is often hard to remember the shortcuts since there are too many shortcuts in an application, and sometimes users do not know where to find the shortcut hints.

Since PC devices are large touch-screen devices carries virtual keyboard (on-screen keyboard), there are growing interest in integrating virtual keyboard with shortcut hints, such as displaying shortcut information onto the virtual keyboard. The demand for adaptive and personalized shortcut hints also rises.

### BRIEF SUMMARY

The present application seeks to address the technical problems associated with current computing technology with regards to displaying shortcut hints. In some examples, the present application addresses a scenario of running multiple operation systems on one host, a scenario of switching among multiple sub-tasks within one application, and easy and adaptive ways of customization.

In the present application, the term shortcut hint may refer to visual hints to indicate the availability and/or usage of a shortcut. The term UI assets for shortcut hints or shortcut UI configuration data may refer to one or more UI elements, such as text, icon, colour scheme, key combination. The term shortcut activation key or keys refers to particular keys or key combinations on a keyboard, such as Ctrl, Shift, Alt, Fn, Win (for Windows), Cmd (for Apple), etc.

In one aspect, the present application describes a computer-implemented method that may include storing in memory, on a computing device having a virtual keyboard, two or more shortcut key mappings, each of the shortcut key mappings having a respective associated context; determining a current context of the computing device; in response to determining the current context, retrieving from the memory one of the two or more shortcut key mappings based on its associated context matching the current context; and detecting selection of a shortcut activation key on the virtual keyboard and, in response, altering display of a plurality of keys on the virtual keyboard using the retrieved one of the two or more shortcut key mappings.

In some implementations, the associated context for each of the two or more shortcut key mappings includes a respective associated application, and determining the current context includes determining an active application.

In some implementations, the associated context for each of the two or more shortcut key mappings includes a respective task within a particular application, and determining the current context includes determining a current task within the particular application. In some cases, determining the current task includes detecting the current context using an application programming interface (API) or a plug-in to obtain data identifying the current task. In some cases, determining the current task includes obtaining a screenshot of a screen output and determining the current task from the screenshot.

In some implementations, the computing device includes one or more virtual machines configured to enable execution of a respective operating system, the associated context for each of the two or more shortcut key mappings includes a respective one of the operating systems, and determining the current context includes determining an active operating system.

In some implementations, the one of the two or more shortcut key mappings includes identification of two or more keys, a respective shortcut UI configuration associated with each of the two or more keys, and altering display includes modifying a keycap for the two or more keys on the virtual keyboard using the shortcut UI configuration from said one of the two or more shortcut key mappings. In some cases, the shortcut UI configuration includes one or more of a character, an icon, a graphic, a font colour, a background colour, opacity, and font to be used in rendering the keycap.

In some implementations, determining the current context occurs in response to detecting selection of the shortcut activation key.

In some implementations, determining the current context occurs in response to detecting a change in the current context and prior to detecting selection of the shortcut activation key.

In some implementations, the one of the two or more shortcut key mappings includes a plurality of shortcuts and data indicating priority as between as least two of the shortcuts, and altering display of a plurality of keys on the virtual keyboard is at least partly based on the data indicating priority.

In some implementations, the method includes tracking usage data regarding the plurality of shortcuts and updating the data indicating priority based on the usage data. In some cases, the usage data includes one or more of a count of uses of a shortcut, a frequency of usage of a shortcut, a time-of-day of usage of a shortcut, a location of usage of a shortcut, and a sequence of usage of two or more shortcuts.

In some implementations, altering display of a plurality of keys on the virtual keyboard includes selecting a subset of the plurality of shortcuts based on the data indicating priority and the plurality of keys corresponds to the subset of the plurality of shortcuts.

In some implementations, retrieving the one of the two or more shortcut key mappings includes retrieving a user-customized shortcut mapping. The method may provide for user customization of the shortcut key mappings. The customization may be performed through the virtual keyboard.

In some implementations, the method may further include detecting user selection of a shortcut edit mode through input via the virtual keyboard; displaying data regarding at least one of the two or more shortcut key mappings; receiving input modifying at least one element of one of the two or more shortcut key mappings to create a modified shortcut key mapping; and saving the modified shortcut key mapping.

In some implementations, detecting user selection of the shortcut edit mode through input via the virtual keyboard includes detecting selection of a shortcut activation key on the virtual keyboard and determining that the selection invokes the shortcut edit mode.

In some implementations, the method may further include subsequently determining the current context of the computing device and, in response to determining the current context, retrieving from the memory the modified shortcut key mapping based on its associated context matching the current context.

In some implementations, saving includes saving the modified shortcut key mapping to a configuration file at an application level or at a system level.

In another aspect, the present application provides a non-transitory, computer-readable medium storing instructions that, when executed by a processor, configure the processor to perform one or more of the methods described herein.

In a further aspect, the present application describes a computing device that includes one or more processors; memory storing two or more shortcut key mappings, each of the shortcut key mappings having a respective associated context; and a touchscreen. The memory may store processor-executable instructions that, when executed by the processor, configured the processor to perform one or more of the methods described herein.

In some implementations, the processor-executable instructions, when executed, are to cause the processor to render a virtual keyboard on the touchscreen; determine a current context; in response to determining the current context, retrieve from the memory one of the two or more shortcut key mappings based on its associated context matching the current context; and detect selection of a shortcut activation key on the virtual keyboard and, in response, alter display of a plurality of keys on the virtual keyboard using the retrieved one of the two or more shortcut key mappings.

In another aspect, the present application describes a computing device having a processor, a touchscreen, and including means to perform one or more of the methods described herein.

### BRIEF DESCRIPTION OF THE FIGURES

Reference will now be made, by way of example, to the accompanying drawings in which:

FIG. 1 illustrates a first example system and computing device;

FIG. 2 illustrates an example touchscreen showing a virtual keyboard;

FIG. 3A and 3B illustrate the updating of a keycap display to signal shortcuts;

FIG. 4 shows, in flowchart form, one example method of displaying shortcut hints;

FIG. 5 shows, in flowchart form, one example method of displaying shortcut hints on a virtual keyboard based on current operating system;

FIG. 6 shows, in flowchart form, an example method of displaying shortcut hints on a virtual keyboard based on active application and current task or state;

FIG. 7 shows, in flowchart form, an example method for editing shortcut hints;

FIG. 8 diagrammatically illustrates an example shortcut key mapping; and

FIG. 9 shows, in flowchart form, an example method for updating shortcut priority rankings.

Like reference numerals are used in the drawings to denote like elements and features.

### DETAILED DESCRIPTION

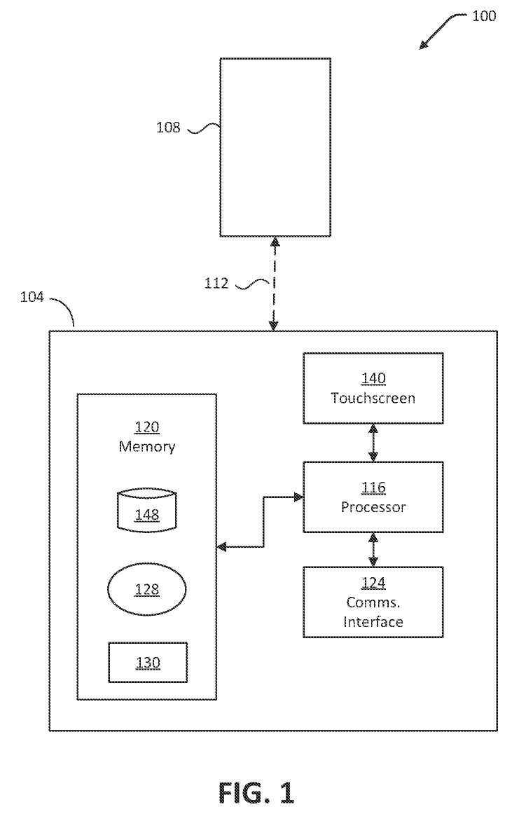

Reference is first made to FIG. 1, which depicts an example system 100 including a device 104 configured to implement one or more of the methods described herein. The device 104 may be in communication with a second computing device 108 via one or more communication links 112, including wired and/or wireless communication links, combinations thereof, links which traverse one or more networks, including local area networks, wide-area networks, the internet, and the like.

The devices 104 and 108 may be any suitable computing devices, such as, but not limited to, mobile computing devices such as phones, smart phones, tablets, laptop computers, handheld and/or wearable devices, and the like, or fixed computing devices, such as desktop computers, servers, kiosks, and the like.

The device 104 includes a processor 116, a memory 120 and a communications interface 124.

The processor 116 may include a central processing unit (CPU), a microcontroller, a microprocessor, a processing core, a field-programmable gate array (FPGA), a graphics processing unit (GPU), or similar. The processor 116 may include multiple cooperating processors. The processor 116 may cooperate with the memory 120 to realize the functionality described herein.

The memory 120 may include a combination of volatile (e.g., Random Access Memory or RAM) and non-volatile memory (e.g., read-only memory or ROM, Electrically Erasable Programmable Read Only Memory or EEPROM, flash memory). All or some of the memory 120 may be integrated with the processor 116. The memory stores applications 128, each including a plurality of computer-readable instructions executable by the processor 116. The execution of the instructions by the processor 116 configures the device 104 to perform the actions discussed herein. In particular, the applications 128 stored in the memory 120 include applications to perform methods for language processing. When executed by the processor 116, the applications 128 configures the processor 116 and/or the device 104 to perform various functions discussed herein in greater detail.

The device 104 further includes a touchscreen 140. The touchscreen 140 may be a capacitive touchscreen. The touchscreen 140 displays graphics, text, and other UI elements under control of the processor 116, and is configured to detect touch events. The touchscreen 140 and its associated hardware and software may provide touch event data to the processor 116 and/or associated applications 128 or other software. The touch event data may include data regarding capacitive touch signals from points on the touchscreen.

The memory may further include one or more operating systems 130, any one of which may in some cases be configured to run within a virtual machine. The one or more operating systems 130 allow the applications 128 to access the processor 116, the memory 120, I/O devices and/or modules, such the touchscreen 140, and the communications interface 124. The operating system 130 may, for example, be iOSTM, AndroidTM, LinuxTM, Microsoft WindowsTM, or the like. Many of the operations, methods, or processes described herein may be implemented within the operating system 130.

The I/O devices and/or modules (not illustrated) may include microphone(s) that can receive the voice/sound inputs; speaker(s) that can output any kind of sound effects; vibration motor(s) that can provide tactile feedback through vibration; and/or a stylus that can serve as an input/interaction device through the touchscreen 140 or other touch-sensitive I/O surfaces.

In some cases, the touchscreen 140 may display a virtual keyboard. The operating system 130 and/or particular applications 128 may include software for utilizing the virtual keyboard. In one example, the software may include an input handling module to process touch inputs from the touchscreen 140 and translate them into key presses. In a further example, the software may include a rendering engine responsible for drawing the keyboard’s visual elements on the touchscreen 140, including keys, backgrounds, visual hints, and animations. In a further example, the software may include one or more application program interfaces that allows the virtual keyboard to either one-directionally or mutually communicate with other software applications 128 or one of the operating systems 130.

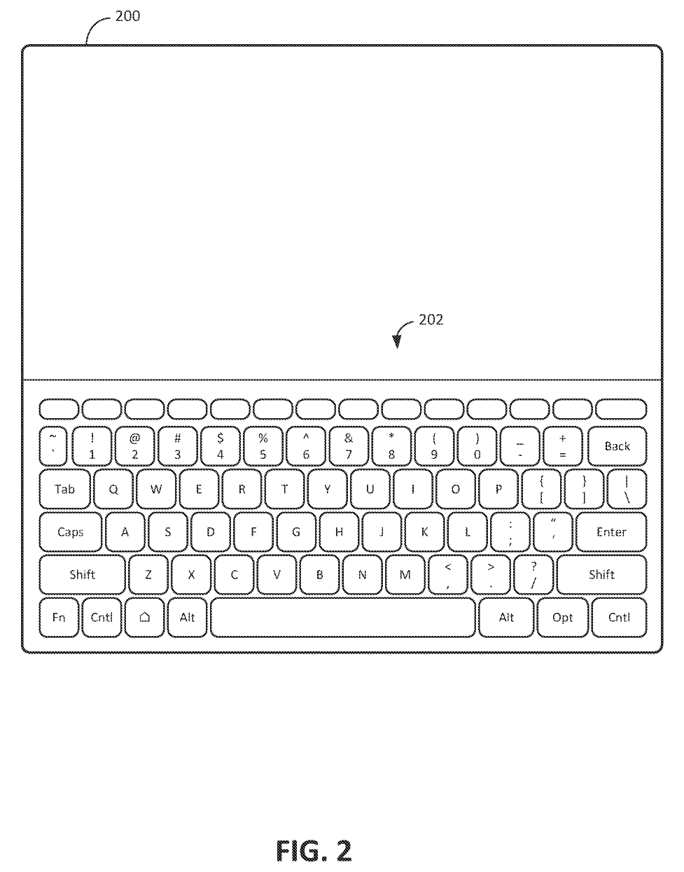

Reference is now made to FIG. 2, which diagrammatically illustrates an example touchscreen 200 showing a virtual keyboard 202. In modeling a conventional hardware keyboard, the virtual keyboard 202 features a plurality of “keycaps” each indicating its associated alphanumeric character or symbol. Some of the keys may be “standard” keys and some may be “function” keys. In some cases, a subset of keys may be the alphanumeric keys, i.e. those keys to which a particular letter or number is assigned, and the remaining keys may be considered “function” keys. The function keys may include some typical function keys, enter key, shift key, etc., but some keyboards may include alternative function keys, such as “Alt”, “Opt”, “Fn” or other such keys. When one or more of these keys are “pressed”, e.g. a touch event is detected on that key, the functional operation of one or more other keys may be changed. In some cases, this may be termed a “shortcut activation” or the key or key combination termed a “shortcut activation key”. For example, pressing “Ctrl” and “Alt” at the same time may trigger a shortcut operation in which another key may be pressed at the same time and a corresponding computer operation may be triggered. As an illustration, in a Microsoft WindowsTM environment, pressing “Ctrl” and “Z” may cause the system to undo the previous action, or pressing “Alt” and “Tab” may cause the system to switch between open windows.

In some cases, the system may have a dedicated shortcut activation key that, when pressed, activates certain shortcut functionality. For example, a Microsoft WindowsTM keyboard may have a Windows key showing a Windows symbol. This may enable functions, such as “Windows key” + “E” which opens the file explorer application.

As noted, pressing a shortcut activation key (whether one key or a combination of keys) may enable activation of shortcut functionality. In some cases, a shortcut may be triggered by the continued press of the shortcut activation key together with another key to select a particular shortcut. In some cases, the shortcut activation key may be pressed and released to activate a shortcut state and another key may then be pressed to select a particular shortcut.

In accordance with an aspect of the present application, the display of a virtual keyboard may be updated upon detecting a shortcut activation key so as to visually aid the user in mapping particular shortcuts to particular keys. As will be described further below, the computing device may store a shortcut key mapping that defines two or more shortcut key mappings. The shortcut key mappings may provide a shortcut UI configuration for a particular shortcut key or key combination. For example, the shortcut key mappings may indicate a particular shortcut operation or function association with the “P” key when shortcuts are activated through the shortcut activation key (or keys). That shortcut key mapping may indicate that the shortcut is to trigger a print operation, and the shortcut UI configuration may provide one or more images or other user interface elements to be used in updating the virtual keyboard keycap for the “P” key. In place of the alphanumeric “P” symbol, the shortcut UI configuration may indicate that an image of a printer is to be displayed on the “P” key.

The shortcut key mapping may be associated with a particular context. For example, a particular set of shortcut key mappings may be associated with a particular application. In this manner, when the computing device detects selection of a shortcut activation key, it first determines the current context, and then selects a shortcut key mapping from memory that corresponds to or is associated with that context. In the case of applications, the computing device may, on detecting selection of the shortcut activation key, determine the active application and then retrieve the shortcut key mapping stored in memory in association with the active application. Other possible contexts are described in some examples herein.

Based on the shortcut key mapping retrieved from memory, the computing device alters the display of the virtual keyboard in order to visually signal available shortcuts by updating the display of one or more of the keycaps associated with possible shortcuts. In some cases, this may include replacing a default symbol or character or other graphic with a symbol, character(s), icon, or other graphical element specified in the shortcut UI configuration. In some implementations, the computing device may be configured to update the display of all keys that trigger a shortcut. In some implementations, the computing device may be configured to update only a subset of keys that trigger a shortcut. The subset may be determined based on a priority ranking associated with the shortcuts. The priority ranking may be user-selected or specified, or may be set by an administrator or default policy. The priority ranking may be determined over time, perhaps periodically, based on usage history of the shortcuts. That is, the subset may be a number of the most commonly used shortcuts. The usage history may be user specific or crowd-sourced or device specific, in different implementations. The priority ranking may change based on context, e.g. a particular active task or menu or other state within an application or within an operating system. In some cases, this may include highlighting or bolding or otherwise visually emphasizing one or more of the shortcut options.

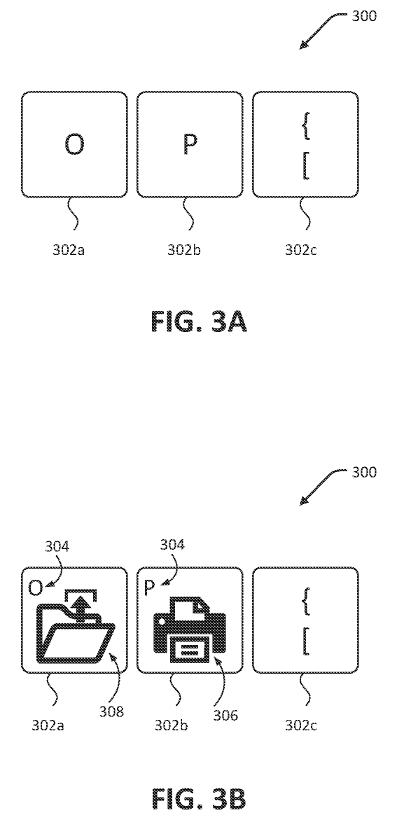

FIG. 3A and 3B illustrate the updating of a keycap display to signal shortcuts. FIG. 3A shows a set of keycaps 302a, 302b, 302c (collectively, 302) on portion of a virtual keyboard 300. The keycaps are rendered on the touchscreen to look like keys on a conventional keyboard. The keycaps have one or more glyphs, e.g. symbols or characters (e.g. alphanumeric character) indicating the text element that is produced by selecting that key. In some cases, a “shift” character may be shown together with a default character, to indicate what symbol is produced when pressing a “shift” key and the keycap.

FIG. 3B shows the portion of the virtual keyboard 300 once a shortcut activation key is detected and the virtual keyboard 300 display is updated based on the shortcut UI configuration in the shortcut key mapping. In this example, the shortcut key mapping indicates a shortcut associated with the “P” key and a shortcut associated with the “O” key. There is no shortcut associated with the “[” key in this example. It will be noted that display of the first and second keycaps 302a and 302b has been updated but that display of the third keycap 302c has not changed.

For the purposes of this example, it is assumed that the “P” key is associated with a print operation and that the “O” key is associated with a file open operation. The retrieved shortcut key mapping may include shortcut UI configuration for each shortcut that provides graphical data for updating the keycap. In this example, the configuration may indicate that the original symbol on the keycap is maintained but placed in smaller text in the upper left corner, as indicated by reference numeral 304. The shortcut UI configuration may further provide an icon or other graphical element for display on the keycap. In this example, the “P” key is associated with a printer icon 306 and the “O” key is associated with a file opening icon 308.

The shortcut UI configuration may include a priority ranking or other indication of relative importance that may impact display of the updated keycap graphics. In some cases, it may indicate that a certain shortcut or set of shortcuts has a higher priority than other shortcuts. On that basis the set of shortcuts may be displayed more prominently. For example, they may be rendered in a different color, or font, or using bolder line weights, or brighter icons. In some cases, the more prominent shortcuts may be displayed with a different, perhaps highlighted, background for the keycap, or may “glow”, “flash”, or otherwise be highlighted visually on the virtual keyboard 300.

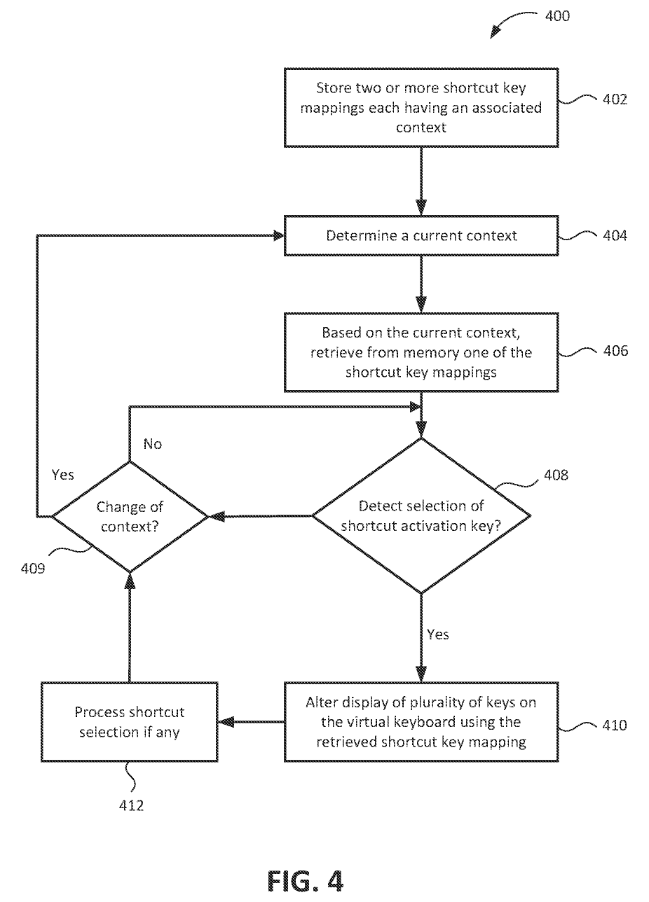

Reference is now made to FIG. 4, which shows, in flowchart form, one example method 400 for rendering shortcuts on a virtual keyboard. The method 400 may be implemented on any computing device with a touchscreen on which a virtual keyboard is displayed. The computing device may be a personal computer, laptop, foldable screen laptop, tablet, smartphone, or any other such computing device. The method 400 may be implemented by way of computer-executable instructions embodied in software stored in the system and executable by one or more of processors in the computing device. The software may be an operating system, an associated service or module, or application software, in some examples. Different portions of the method 400 may be implemented in different software in some implementations.

The method 400 includes storing two or more shortcut key mappings in memory in operation 402. Each shortcut key mapping has an associated context. As described above and as further detailed below, the shortcut key mapping may include shortcut UI customization data or information for visually updating or altering the display of a key on the virtual keyboard. The key is a particular key to be used for selecting and triggering the associated shortcut operation or function. Operation 402 may include storing a plurality of shortcut key mappings, each associated with a respective context. The associated context may include, for example, a particular operating system, a particular active application, a particular task within an active application, or any combination thereof.

In operation 404, the computing device determines a current context. This may include determining the current active operating system, the active application and/or the active task within an active application. Various techniques may be used by the computing device to determine the current contexts in these circumstances, as will be described further below.

In operation 406, the computing device retrieves one of the shortcut key mappings from memory based on the determined current context. In particular, it identifies a shortcut key mapping having an associated context that matches the current context determined in operation 404.

The computing device, in this example, then awaits detection of a shortcut activation key. In some cases, this may be activated through detecting pressing of two or more keys at the same time (e.g., Ctrl+Alt). In some cases, this may be detected as the press of a dedicated shortcut activation key.

If a shortcut activation key is not detected, the computing device may evaluate whether there has been a change of context in operation 409, in which case it may re-perform operations 404 and 406 to retrieve a new shortcut key mapping based on a new current context. Detecting a change of context may include determining that a virtual machine has been launched, which may include launch of a new operating system. It may include detecting a change in the active application. It may include a change in the state or active task within an application.

If a shortcut activation key is detected in operation 408, then in operation 410 the computing device uses the retrieved shortcut key mapping to alter display of two or more keys on the virtual keyboard. As described above, this alteration of the display may be based on shortcut UI configuration information in the shortcut key mapping. The mapping may further indicate which specific keys to alter, perhaps based on a priority ranking or designation of a subset of the shortcut keys to be highlighted or emphasized. The mapping indicates how the keys are to be altered, including icons or graphics to be rendered on the keycap in place of the default icon or character(s) on the keycap. It may indicate colors, fonts, background colors, opacity, displacement of default text/icons, or other such features to be used in rendering the keycap.

In operation 412, the computing device may detect selection of one of the shortcut keys or cancellation of the shortcut activation (e.g., shortcut activation may be cancelled through selecting a non-shortcut key, selecting an Escape key, selecting a portion of the touchscreen outside of the virtual keyboard, or in some other manner). If a shortcut key is pressed while the shortcuts are being displayed on the virtual keyboard, then the computing device processes that shortcut, i.e. carries out the associated function or operation triggered by the shortcut. Display of the shortcuts on the virtual keyboard then ceases and the display is updated to show the conventional virtual keyboard.

The method 400 then returns to operation 409 to determine whether there has been a change of context and, otherwise, to await any further detection of the shortcut activation key(s).

In the above-described method 400, the system proactive determines context and detects changes of context and retrieves the associated shortcut key mapping from memory. In another implementation, the computing device awaits detection of the shortcut activation key(s) and, in response, carries out the operations of determining a current context, retrieving the associated shortcut key mapping, and altering the display of the virtual keyboard based on the retrieved shortcut key mapping.

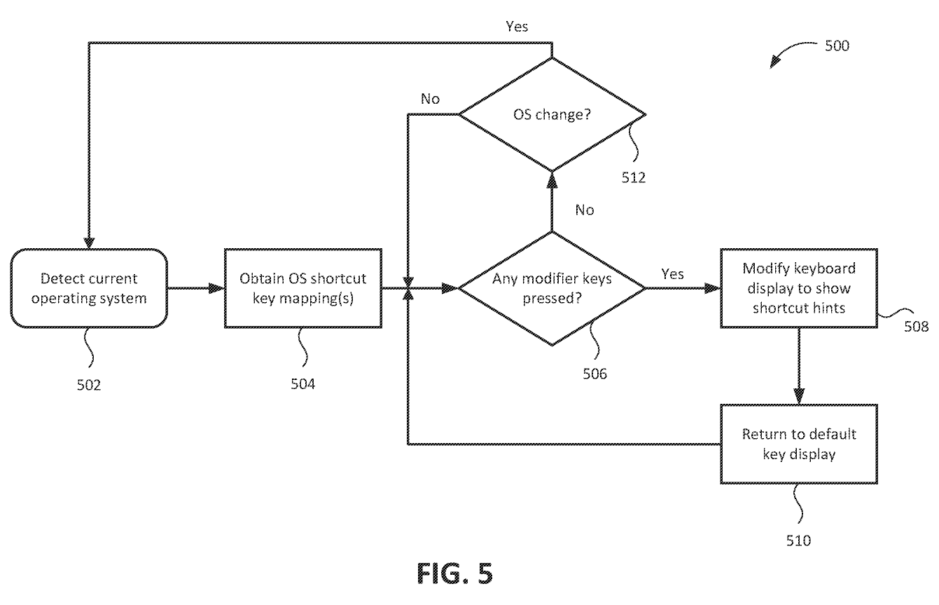

Reference is now made to FIG. 5 which shows, in flowchart form, one example method of displaying shortcut hints on a virtual keyboard. In this method, a change of context occurs in which a computing device switches to use of another operating system, (e.g., by virtual machine), and, as a result, the device switches to a shortcut profile for the new OS and it retrieves updated UI assets. That is, the method 500 provides for adaptive shortcut display based on a current operating system. The method 500 is applicable to computing devices having a touchscreen that displays a virtual keyboard.

The method 500 includes detecting a current operating system in operation 502. Detecting the current operating system may include determining the type of operating system (e.g., iOSTM, AndroidTM, LinuxTM, or Microsoft WindowsTM) and/or determining the version of an operating system (e.g. WindowsTM 10, WindowsTM 11, macOS BisSurTM, macOS SequoiaTM, Linux UbuntuTM, Linux FedoraTM). The computing device may have a default operating system launched during startup of the device, e.g. on startup a basic input/output system (BIOS) (or an Extensible Firmware Interface (EFI) on some devices) typically runs to perform some functionality tests on hardware elements and to then check particular memory locations for operating system software. Upon locating operating system software, the BIOS launches a bootloader routine that performs the operation of loading the operating software to memory and initiating its execution.

The method 500 may be an application, service, or routine that is part of the default operating system or run as software within the default operating system in some cases. The initial determination of the current operating system in operation 502 may be a default determination based on the default operating system within which the software runs. However, as will be described below, some computing devices may be configured so as to permit more than one operating system to operate (only one of which will be the ‘active’ operating system). In particular, if the computing device is configured to permit operation of one or more virtual machines (VMs), a different operating system may be launched and operating within a VM.

In operation 504, based on the type or identifier of the current operating system, the computing device may retrieve shortcut key mapping(s) from memory. That is, there may be a set of one or more shortcut key mappings that are applicable and invokable in the context of the current operating system. In operation 506, the computing device determines whether a shortcut activation key (or keys) have been pressed. If so, then in operation 508, it modifies the display of the virtual keyboard. In particular, it alters the appearance on the touchscreen of at least one of the keys associated with a shortcut. The text and/or graphics shown on the keycap may be changed to text or graphics specified in shortcut UI configuration data associated with that shortcut key. In some cases, color, background, highlighting or other graphical indicia may be altered with regard to the key.

In operation 510, the computing device reverts to display of the default virtual keyboard without the shortcut indicia shown. This may occur following selection of a shortcut by way of key press on the virtual keyboard, or through cancelation or expiry of the shortcut activation.

While awaiting detection of a shortcut activation key in operation 506, the computing device also monitors for a change in operating system in operation 512. The change in operating system may be detected, for example, through detecting or identifying launch of a virtual machine on the computing device. The virtual machine may rely on the computing device’s operating keyboard/touchscreen software, in which case the software may determine the operating system in order to potentially load a different set of shortcut key mappings that correspond to the operating system being used within the virtual machine. The virtual machine may expose an operating system identifier to enable determination of the active operating system. In some cases, the VM may have an application programming interface (API) through which the software can obtain the operating system identifier. In some cases, the operating system may be identifiable based on its kernel type.

In some implementations, the operating system may be identified by querying the resource management interfaces of the OS (e.g., Linux's proc filesystem or Windows' WMI). The device may determine the OS type based on how it manages resources like CPU, memory, and storage. In some cases, the device may identify the OS by analyzing the available system APIs (e.g., Windows API, Linux syscalls) exposed by the OS. In some cases, the device may use built-in system properties or functions (e.g., OS/sys library in Python) to determine the active operating system.

In one variation, the OS determination and retrieval of shortcut key mapping may occur in response to detection of a shortcut activation key(s).

In the above example, the computing device retrieves a different set of shortcut key mappings based on the current active operating system. Those different shortcut key mappings may have different UI assets, such as icons, graphics or other visual indicia. They may map different keys to different functions in some cases. They indicate different keys or key combinations as the shortcut activation key(s) for accessing shortcuts via the virtual keyboard.

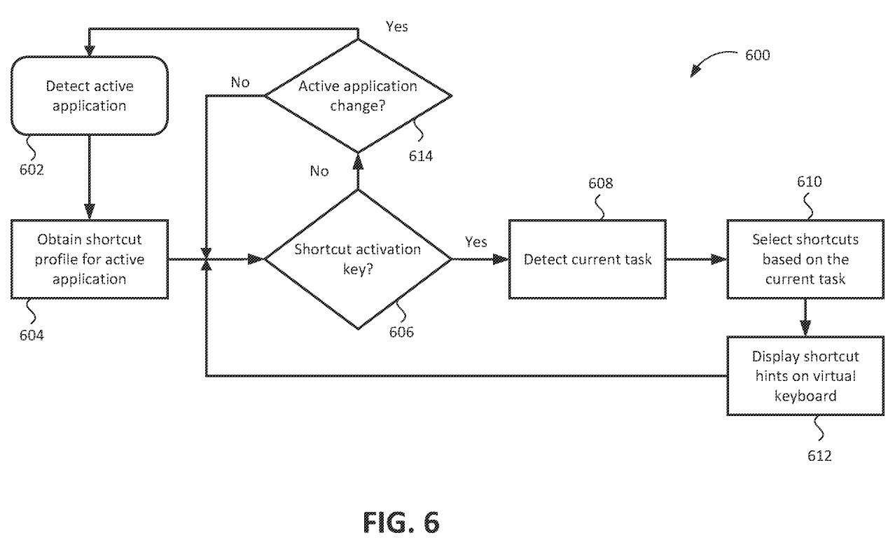

Reference is now made to FIG. 6, which illustrates, by flowchart, another example method 600 of displaying shortcut hints on a virtual keyboard. As with other examples, the method 600 may be implemented on any computing device with a touchscreen on which a virtual keyboard is displayed. The computing device may be a personal computer, laptop, foldable screen laptop, tablet, smartphone, or any other such computing device.

In operation 602, the computing device determines the active application. The present method 600 may be implemented as a service or routine running within a kernel and may have an API or other mechanism for determining an active application. In some cases, it can be determined through detecting a title or label on a front-most window. In operation 604, the computing device retrieves a shortcut key mapping from memory based on the identified active application. The shortcut key mapping may be one data file or may be multiple data files. The shortcut key mapping may include different subsets of key mappings, each associated with a particular context, such as a particular task or state of the application.

In operation 606, the computing device determines whether a shortcut activation key (or keys) have been pressed on the virtual keyboard. If shortcut activation keys have been pressed, then in this example the computing device determines the current task (or state) of the application in operation 608. The current task or state may be determined any one of a variety of ways. In some cases, the application may expose its active task or state through an API. For instance, the application may expose certain events or hooks (via APIs, SDKs, or global event listeners) that virtual keyboard software can hook into or listen for. These events could indicate tab changes or subtask transitions. For example, when the user switches tabs in a video editing app (e.g., from "Color Correction" to "Special Effects"), the app might dispatch a particular event so that change is detectable.

In some cases, a plug-in may be operating within the application that exposes that information. If an application allows third-party extensions or plugins that can track the UI state, then virtual keyboard software may employ a plugin that directly hooks into the application’s internal logic to determine the active tab, e.g., task or state.

In some cases, the computing device may activate a screenshot function and pass the resulting image to a model or routine that identifies the application task or state from the screenshot. The model or routine may be trained to identify application task or state from a corpus of training screenshots for that application (or a variety of applications). In many cases, the current active task or state is identifiable based on header information, such as an active tab within the application. As an example, video software may have a viewing state, an editing state, a file management state, or other such states/tasks.

Different shortcuts may be available dependent upon the different state of the application. Even in cases where the shortcuts are the same, the shortcuts may have different priorities associated with them in the different states since some shortcuts will be more important or applicable when in certain states/tasks than when in other states/tasks.

In operation 610, the computing device selects the plurality of shortcuts based on the determined current task. In some implementations, this may mean selecting a shortcut key mapping file based on the current task. In some implementations, this may mean selecting a subset of mappings from a shortcut key mapping loaded in memory. In some implementations, this may include querying or searching a loaded shortcut key mapping based on the current task or state and received, in response, a subset of shortcut key mappings.

In operation 612, the display of the virtual keyboard is altered based on the selected set or subset of shortcut key mappings. As described above, the altering may include altering the graphics and/or text and/or graphical background or indicia associated with one or more keys mapped to shortcuts in the shortcut key mappings. The shortcut key mappings may provide UI assets, such as the shortcut UI configuration data, for making the alterations in the display. Priority data associated with each key having an entry in the set or subset of shortcut key mappings may be used by the computing device in determining which keys to alter or how they are altered. In many implementations, the display then reverts to the default virtual keyboard display once a shortcut key is pressed, or once the shortcut activation is cancelled or times out.

The computing device monitors for a change in the active application in operation 614. In some cases, it may register for and receive notifications of changes in active application or active window. In some cases, the method 600 may be implemented at the kernel level and may have a hook or other mechanism to intercept or detect active application/window change requests. On detecting a change in active application (e.g. a change in active window and/or launch of a new application), the method 600 returns to operation 602 to identify the application and then to retrieve the associated set of shortcut key mappings in operation 604.

In another implementation, instead of waiting for detection of a shortcut activation key or keys, the computing device may proactively determine the current task (operation 608) and select the shortcut key mappings associated with that current task (operation 610), so that it is prepared upon detection of a shortcut activation key to update the keyboard display. In this implementation, the computing device is further configured to monitor for changes in the active task/state so that it can select the associated shortcut key mappings. It may detect a change in current task through monitoring user inputs, such as tab changes, menu selections, window changes, etc. It may detect a change in task through an applicable API exposed by the application itself. It may detect a change through a hook or other mechanism at the kernel level.

In some cases, users may be afforded the option of changing or customizing shortcuts. In some cases, this may be carried out within an application with which the shortcuts are associated. For example, a user may change a key combination that triggers a particular shortcut in an application setting menu/preference menu. This change may be implemented through modifying the associated shortcut key mappings. Virtual keyboard software may read the shortcut key mappings from application data or a configuration file. It then updates any shortcut UI assets loaded in memory, such as those provided by the shortcut UI configuration data, if changed.

In some cases, user-based customization may be triggered whilst in the shortcut activation state. That is a user action (such as selection of a shortcut activation key) on virtual keyboard may cause the virtual keyboard to enter a “shortcut mode”. User input may then be detected that triggers a “shortcut edit mode”. For example, the user may perform a key combination that signals an intention to edit a shortcut hint for that key combination. For example, in shortcut edit mode, a long-press of an associated shortcut key or key combination, e.g. long-presses of Ctrl key and P key, may trigger the shortcut edit mode. In some examples, an editing window may then be provided to enable a user to modify text, select an icon, or otherwise alter the shortcut UI configuration for the shortcut Ctrl+P. In this manner, the next time when Ctrl is pressed (or another shortcut activation key), a different shortcut hint will be displayed on keycap ‘P’.

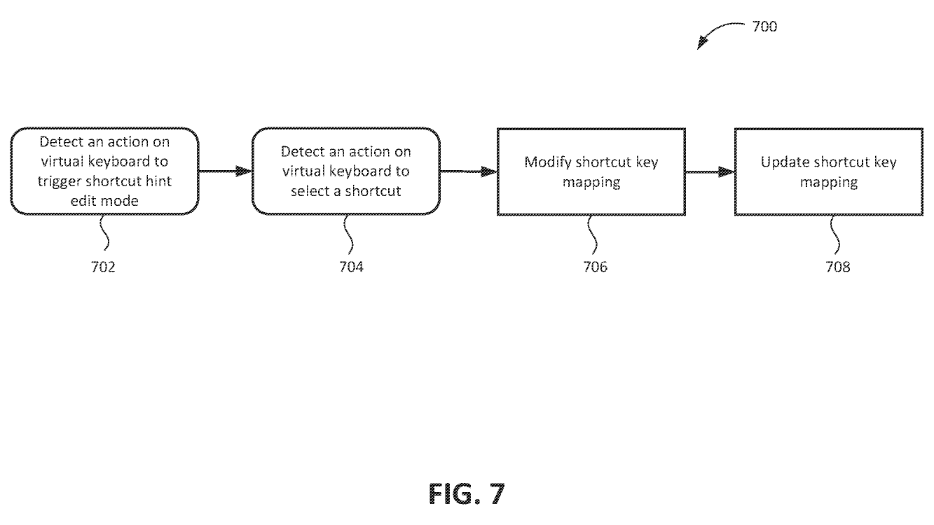

FIG. 7 shows one example method 700, in flowchart form, for editing shortcut hints. In operation 702, the computing device may detect an action on the virtual keyboard that triggers a shortcut edit mode. The action may be a particular key combination. In one example, the action may be a shortcut activation key press that continues for longer than a threshold length of time – i.e., a “long-press” of the shortcut activation key(s). Once in the shortcut edit mode, the computing device may, in some cases, display details of the shortcut key mappings and, for instance, the shortcut UI configuration. A user may select a particular one of the shortcuts for editing from the display, as indicated by operation 704. The display may be overtopping the virtual keyboard in some cases or may be in a different area of the touchscreen. In some cases, the shortcut edit mode may away user selection of a particular shortcut for editing from activation of the associated key on the virtual keyboard. The shortcut edit mode may be visually signaled on the virtual keyboard, such as through pulsing or flashing of the shortcut hints to indicate that they are in an edit mode.

Upon selecting a particular shortcut, the computing device may then receive edits to the shortcut. In some cases, the edits may include changes to the text and/or graphics specified in the shortcut UI configuration. For instance, a user may change the icon associated with the shortcut. In some cases, the change may include deletion of the shortcut. In some cases, the change may alter the key or key combination mapped to the shortcut function. In some cases, the change may be addition of a new shortcut, in which case the user may specify an available key or key combination, an associated function or operation, and shortcut UI configuration data for signaling the shortcut hint visually on the virtual keyboard. The modification(s) are indicated as operation 706. The modified shortcut key mapping is then saved in memory in operation 708. In some cases, the modified shortcut key mapping is then saved to application data or a configuration file at the application or system level in operation 708.

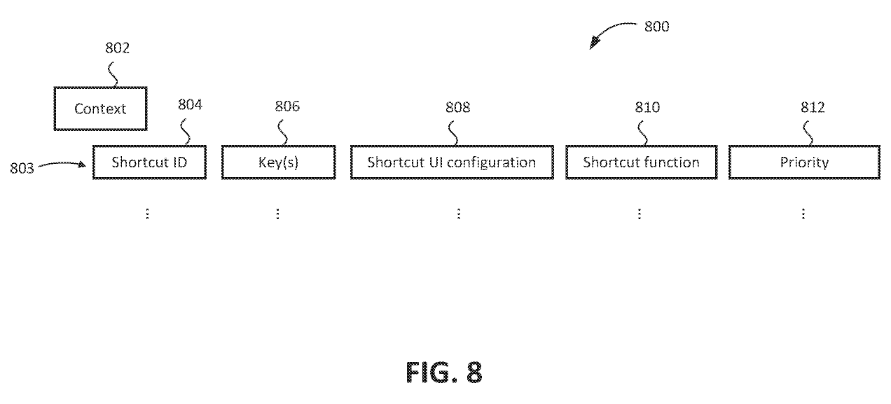

Reference is now made to FIG. 8, which diagrammatically illustrates an example shortcut key mapping 800. In some examples, the shortcut key mapping 800 may be stored in persistent memory and retrieved as needed by the computing device and/or loaded into random-access memory during application execution.

The shortcut key mapping 800, in this example, includes an associated context 802. This may indicate an operating system or operating system identifier, an application or application identifier, a task or state within an application or an associated identifier of a task or state, or any combination thereof. The context 802 may be associated with a plurality of shortcut entries 803. In some cases, the context 802 may be an individual data field within each shortcut entry 803, depending on the data structure used in implementing the shortcut key mapping 800. In some cases, the context 802 is metadata associated with the file storing the shortcut key mapping 800 but does not appear in the payload of the data file itself. In some cases, the shortcut key mapping 800 applies to a plurality of contexts such that the context 802 associated with each shortcut entry 803 is specified in the file.

In this illustrative example, each shortcut entry 803 may include a shortcut identifier 804, an associated key or keys 806, shortcut UI configuration data 808, shortcut function 810, and a priority 812 or ranking. The identifier 904 may be unique identifier, such as a unique integer or other label. The associated key or keys 806 may identify the one or more keys of the virtual keyboard used to select or activate shortcut. The keys may be identified by default keycap identifier (e.g., the “P” key), an ASCII code associated with the keycap identifier, a numerical index to the keycap(s), or some other indicator identifying the one or more keycaps.

The shortcut UI configuration data 808 includes data used by the computing device to alter the appearance of the associated one or more keycaps to signal the availability of the shortcut, i.e. as a shortcut “hint”. It may include text, graphics, icons, or other such data. It may include a link or path to a graphics file containing an icon or image or animated graphic or the like.

The shortcut function 810 specifies the function or operation triggered through selection of the shortcut. It may include a description of the function or operation in some cases. It may include code for triggering the operation or function in some cases.

The priority 812 or ranking may specify a relative priority of the shortcut vis-à-vis other shortcut entries 803 in the shortcut key mapping 800. The priority 812 may be used in identifying a subset of shortcuts to emphasize or highlight when rendering UI hints on the virtual keyboard, for example. The priority 812 may, in some cases, indicate an associated task or state such that the priority ranking applies when in that task or state.

The priority 812 may be used in various manners. In some cases, only a subset of shortcuts is selected to be shown on the adapted virtual keyboard based on being the highest priority shortcuts. In some cases, the display of shortcuts may vary dependent upon priority. For example, different opacity/transparency may be used depending on the shortcut’s priority. Lower priority shortcuts may be shown with greater transparency to reduce their visual importance. Color intensity or contrast may be similarly used to signal a shortcut’s relative priority. As an example, higher priority shortcut hints may be displayed in a bright color which has higher contrast to the keycap background, while less important ones might be in darker shades.

It will be appreciated that the above example is illustrative and not restrictive and that different data structures may be used in different computing environments and implementations. Different implementations may include more or fewer fields.

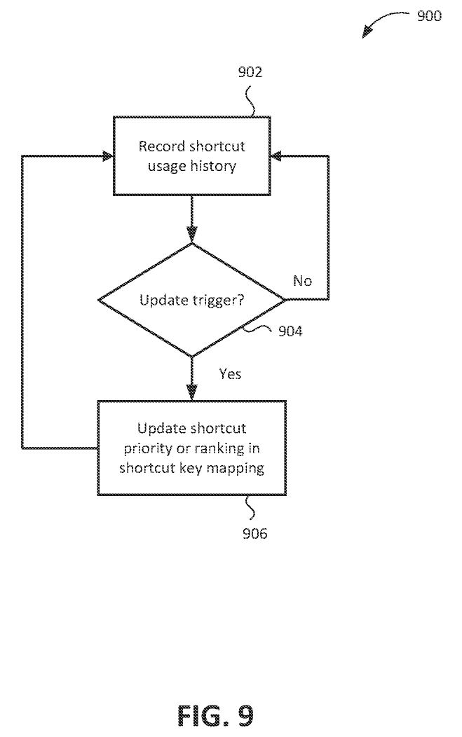

In some cases, the prioritization or ranking associated with shortcuts may be changed over time based on usage. Reference is now made to FIG. 9, which shows, in flowchart form, an example method 900 for updating shortcut priority rankings. In this method 900, virtual keyboard software may track usage of each shortcut, in some cases in association with a particular application and/or in association with a particular task/state within an application. Over time, each shortcut may then be ranked based on occurrence/frequency. Using the shortcut ranking or priority data, the display of shortcut hints may be modified to reflect the updated priority or ranking.

In operation 902, the computing device tracks the use of shortcuts on the computing device. It may record usage history in memory. In some implementations, it maintains a count of use of each of the shortcuts. The counts may be global, i.e. a count of all uses of that shortcut on the computing device irrespective of application or user or task. The counts may be specific to a user, to an operating system, to an application, or to a task/state. In some cases, the usage history is simply a counter tracking the number of times that shortcut has been invoked. In some cases, the usage history may record a timestamp with each usage. The usage history may filter or discard uses older than a maximum age.

In some embodiments, other data may be tracked as part of the usage history, such as GPS data indicating a location during which particular shortcuts are invoked, or time-of-day data indicating a time at which the shortcuts are invoked. In another example, a sequence of shortcut usage may be tracked. That is, the device may record the fact that a particular second shortcut is used after a first shortcut. This data may be used to increase the priority or ranking of the particular second shortcut in a context in which the first shortcut has been invoked.

The stored shortcut usage data may be encrypted in some implementations.

In operation 904, the computing device determines whether an update to priority or ranking has been triggered. The trigger may be based on a time elapses since the previous update. That is, the update may be periodic or scheduled. The trigger may be based on an elapsed time of use of an operating system or an application in some cases. The trigger may be based on a count of shortcut activations, i.e. the number of times that the shortcut activation key(s) has been detected. The trigger may be based on a total number of shortcut invocations since the most recent update. Other such time-based or usage-based triggers may also be used.

If an update has been triggered, then in operation 906 the computing device may redetermine the priority or ranking of shortcuts. In some implementations, this may include modifying the shortcut key mapping to change priority or ranking values based on the accumulated usage history. For example, if the usage history includes a count of the number of times that each shortcut has been used, then the re-determination may rank the shortcuts based on their respective counts. In some cases, it may be ranks or prioritize the shortcuts into buckets: e.g. high-use or high-priority shortcuts with more than M uses and low-use or low-priority shortcuts with fewer than M uses. More than two buckets may be used for grouping/ranking in some implementations.

The data may be provided to a scoring model, which may be a rule-based model, weighted-average model, or machine learning model in various implementations. In some cases, the usage data may be preprocessed before being provided to the model. For example, data may be cleaned and/or normalized. Normalization may be based on total count of shortcuts invoked across all users of the computing device, or all invocations by a particular user, or within a particular application, etc. In some cases, the preprocessing may include filtering the data to include only data within certain time windows or associated with particular users, etc.

With the updated shortcut key mapping stored in memory, the next time the shortcut option is invoked, the computing device will utilize the new priority or ranking in determining how to alter the display of the virtual keyboard to show shortcut hints.

In the above method 900 the computing device may seek user input authorizing the change in ranking or prioritization in some implementations.

In another implementation, the computing device may track and record usage history, such as a count of usage of each shortcut, within the associated shortcut entry in the shortcut key mapping. The count may then be used when determining the display of shortcut hints to determine the priority or ranking of the shortcuts. That is, the top N shortcuts may be displayed when the virtual keyboard is altered on the touchscreen. Or the top N shortcuts may be displayed more prominently, using different colors, backgrounds, highlighting, etc. Or the shortcuts with a count above a threshold minimum count may be displayed when the virtual keyboard is altered on the touchscreen.

Embodiments have been described above in conjunctions with aspects of the present disclosure upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

In the present disclosure, the terms “a” or “an” are defined to mean “at least one”, that is, these terms do not exclude a plural number of items, unless stated otherwise.

In the present disclosure, terms such as “substantially”, “generally” and “about”, which modify a value, condition or characteristic of a feature of an example embodiment, should be understood to mean that the value, condition or characteristic is defined within tolerances that are acceptable for the proper operation of the example embodiment for its intended application.

In the present disclosure, unless stated otherwise, the terms “connected” and “coupled”, and derivatives and variants thereof, refer herein to any structural or functional connection or coupling, either direct or indirect, between two or more elements. For example, the connection or coupling between the elements can be acoustical, mechanical, optical, electrical, thermal, logical, or any combinations thereof.

In the present disclosure, expressions such as “match”, “matching” and “matched”, including variants and derivatives thereof, are intended to refer herein to a condition in which two or more elements are either the same or within some predetermined tolerance of each other. That is, these terms are meant to encompass not only “exactly” or “identically” matching the two elements but also “substantially”, “approximately” or “subjectively” matching the two or more elements, as well as providing a higher or best match among a plurality of matching possibilities.

In the present disclosure, the expression “based on” is intended to mean “based at least partly on”, that is, this expression can mean “based solely on” or “based partially on”, and so should not be interpreted in a limited manner. More particularly, the expression “based on” could also be understood as meaning “depending on”, “representative of”, “indicative of”, “associated with” or similar expressions.

In the present disclosure, the terms "system" and "network" may be used interchangeably in different embodiments of this application. "At least one" means one or more, and "a plurality of" means two or more. The term "and/or" describes an association relationship of associated objects, and indicates that three relationships may exist. For example, A and/or B may indicate the following three cases: Only A exists, both A and B exist, and only B exists, where A and B may be singular or plural. The character "/" indicates an "or" relationship between associated objects. "At least one of the following items (pieces)" or a similar expression thereof indicates any combination of these items, including a single item (piece) or any combination of a plurality of items (pieces). For example, "at least one of A, B, or C" includes: only A; only B; only C; A and B; A and C; B and C; or A, B, and C, and "at least one of A, B, and C" may also be understood as including: only A; only B; only C; A and B; A and C; B and C; or A, B, and C. In addition, unless otherwise specified, ordinal numbers such as "first" and "second" in embodiments of this application are used to distinguish between a plurality of objects, and are not used to limit a sequence, a time sequence, priorities, or importance of the plurality of objects.

A person skilled in the art should understand that embodiments of this application may be provided as a method, an apparatus (or system), computer-readable storage medium, or a computer program product. Therefore, this application may use a form of a hardware-only embodiment, a software-only embodiment, or an embodiment with a combination of software and hardware. Moreover, this application may use a form of a computer program product that is implemented on one or more computer-usable storage media (including but not limited to a disk memory, an optical memory, and the like) that include computer-usable program code.

This application is described with reference to the flowcharts and/or block diagrams of the method, the device (system), and the computer program product according to this application. It should be understood that computer program instructions may be used to implement each process and/or each block in the flowcharts and/or the block diagrams and a combination of a process and/or a block in the flowcharts and/or the block diagrams. The computer program instructions may be provided for a general-purpose computer, a dedicated computer, an embedded processor, or a processor of another programmable data processing device and enable a machine to execute the instructions. When executed by any computer or the processor of a programmable data processing device, the instructions cause the apparatus to implement specific functions as described in one or more procedures in the flowcharts and/or one or more blocks in the block diagrams. The computer program instructions may alternatively be stored in a computer-readable memory that can indicate a computer or another programmable data processing device to work in a specific manner, so that the instructions stored in the computer-readable memory generate an artifact that includes an instruction apparatus. The instruction apparatus implements a specific function in one or more procedures in the flowcharts and/or one or more blocks in the block diagrams.

The computer program instructions may alternatively be loaded onto a computer or another programmable data processing device, so that a series of operations and steps are performed on the computer or the another programmable device, so that computer-implemented processing is generated. Therefore, the instructions executed on the computer or on another programmable device provide steps for implementing specific functions as described in one or more procedures in the flowcharts and/or one or more blocks in the block diagrams.

Although the present disclosure has been described with reference to specific features and embodiments thereof, it is clear that a person skilled in the art can make various modifications and variations to this application without departing from the scope of this disclosure. The specification and drawings are, accordingly, to be regarded simply as an illustration of embodiments as defined by the appended claims, and are contemplated to cover any and all modifications, variations, combinations or equivalents that fall within the scope of the present disclosure.

What is claimed is:

1. A computer-implemented method, comprising:
storing in memory, on a computing device having a virtual keyboard, two or more shortcut key mappings, each of the shortcut key mappings having a respective associated context;
determining a current context of the computing device;
in response to determining the current context, retrieving from the memory one of the two or more shortcut key mappings based on its associated context matching the current context; and
detecting selection of a shortcut activation key on the virtual keyboard and, in response, altering display of a plurality of keys on the virtual keyboard using the retrieved one of the two or more shortcut key mappings.

2. The computer-implemented method of claim 1, wherein the associated context for each of the two or more shortcut key mappings includes a respective associated application, and wherein determining the current context includes determining an active application.

3. The computer-implemented method of claim 1, wherein the associated context for each of the two or more shortcut key mappings includes a respective task within a particular application, and wherein determining the current context includes determining a current task within the particular application.

4. The computer-implemented method of claim 3, wherein determining the current task includes detecting the current context using an application programming interface (API) or a plug-in to obtain data identifying the current task.

5. The computer-implemented method of claim 3, wherein determining the current task includes obtaining a screenshot of a screen output and determining the current task from the screenshot.

6. The computer-implemented method of claim 1, wherein the computing device includes one or more virtual machines configured to enable execution of a respective operating system, wherein the associated context for each of the two or more shortcut key mappings includes a respective one of the operating systems, and wherein determining the current context includes determining an active operating system.

7. The computer-implemented method of claim 1, wherein the one of the two or more shortcut key mappings includes identification of two or more keys, a respective shortcut UI configuration associated with each of the two or more keys, and wherein altering display includes modifying a keycap for the two or more keys on the virtual keyboard using the shortcut UI configuration from said one of the two or more shortcut key mappings.

8. The computer-implemented method of claim 7, wherein the shortcut UI configuration includes one or more of a character, an icon, a graphic, a font color, a background color, opacity, and font to be used in rendering the keycap.

9. The computer-implemented method of claim 1, wherein determining the current context occurs in response to detecting selection of the shortcut activation key.

10. The computer-implemented method of claim 1, wherein determining the current context occurs in response to detecting a change in the current context and prior to detecting selection of the shortcut activation key.

11. The computer-implemented method of claim 1, wherein the one of the two or more shortcut key mappings includes a plurality of shortcuts and data indicating priority as between as least two of the shortcuts, and wherein altering display of a plurality of keys on the virtual keyboard is at least partly based on the data indicating priority.

12. The computer-implemented method of claim 11, further comprising tracking usage data regarding the plurality of shortcuts and updating the data indicating priority based on the usage data.

13. The computer-implemented method of claim 12, wherein the usage data includes one or more of a count of uses of a shortcut, a frequency of usage of a shortcut, a time-of-day of usage of a shortcut, a location of usage of a shortcut, and a sequence of usage of two or more shortcuts.

14. The computer-implemented method of claim 11, wherein altering display of a plurality of keys on the virtual keyboard includes selecting a subset of the plurality of shortcuts based on the data indicating priority and wherein the plurality of keys corresponds to the subset of the plurality of shortcuts.

15. The computer-implemented method of claim 1, further comprising:
detecting user selection of a shortcut edit mode through input via the virtual keyboard;
displaying data regarding at least one of the two or more shortcut key mappings;
receiving input modifying at least one element of one of the two or more shortcut key mappings to create a modified shortcut key mapping; and
saving the modified shortcut key mapping.

16. The computer-implemented method of claim 15, wherein detecting user selection of the shortcut edit mode through input via the virtual keyboard includes detecting selection of a shortcut activation key on the virtual keyboard and determining that the selection invokes the shortcut edit mode.

17. The computer-implemented method of claim 15, further comprising subsequently determining the current context of the computing device and, in response to determining the current context, retrieving from the memory the modified shortcut key mapping based on its associated context matching the current context.

18. The computer-implemented method of claim 15, wherein saving includes saving the modified shortcut key mapping to a configuration file at an application level or at a system level.

19. A non-transitory, computer-readable medium storing instructions that, when executed by a computing device, cause the computing device to perform operations, the operations comprising:
storing in memory, on the computing device having a virtual keyboard, two or more shortcut key mappings, each of the shortcut key mappings having a respective associated context;
determining a current context of the computing device;
in response to determining the current context, retrieving from the memory one of the two or more shortcut key mappings based on its associated context matching the current context; and
detecting selection of a shortcut activation key on the virtual keyboard and, in response, altering display of a plurality of keys on the virtual keyboard using the retrieved one of the two or more shortcut key mappings.

20. A computing device comprising:
one or more processors;
memory storing two or more shortcut key mappings, each of the shortcut key mappings having a respective associated context; and
a touchscreen;
wherein the memory further stores processor-executable instructions that, when executed by the processor, configured the processor to:
render a virtual keyboard on the touchscreen;
determine a current context;
in response to determining the current context, retrieve from the memory one of the two or more shortcut key mappings based on its associated context matching the current context; and
detect selection of a shortcut activation key on the virtual keyboard and, in response, alter display of a plurality of keys on the virtual keyboard using the retrieved one of the two or more shortcut key mappings.
